(19) United States
(12) Patent Application Publication
(10) Pub. No.: US 2011/0119348 A1
(43) Pub. Date: May 19, 2011

(54) METHODS AND SYSTEMS FOR TRANSMITTING DISK IMAGES

(76) Inventor: Nicholas Paul Gibbons, Wellington (NZ)

(21) Appl. No.: 13/000,951

(22) PCT Filed: Jun. 26, 2009
(86) PCT No.: PCT/NZ09/00126

§ 371 Date: Dec. 22, 2010

(30) Foreign Application Priority Data
Jun. 27, 2008 (NZ) 569475

(51) Int. Cl. G06F 15/16

(52) U.S. Cl. 709/217; 709/231

(57) ABSTRACT

A method of transmitting multiple data segments of a disk image from a server to at least two clients that have differing disk image types, the method including the steps of the server: streaming multiple data segments forming at least part of two different disk image types to the clients, and interlacing data segments of a first image type with data segments of a second image type.

### FIELD OF THE INVENTION

The present invention relates to methods and systems for transmitting disk images. In particular, the present invention relates to a method and system for transmitting multiple data segments of a disk image from a server to at least two clients, and from a client to a server.

### BACKGROUND

It is known for a computer to access a copy of a disk image from another computer in order to transfer that image to itself.

A number of documents describe this functionality. For example, European patent application EP 1021782 describes broadcasting a single image to one or more computers using peer to peer or master slave configurations. However, this is strictly limited to the provision of a single image at any one time.

U.S. Pat. No. 6,108,697 describes a system that repeats a single image download over a network. The image has a number of join points to allow multiple computers to download the image starting at different points. However, this system only allows a single image to be transferred.

U.S. Pat. No. 6,594,743 describes a method and system where source data is read from a source disk and written to a target disk in a sector by sector manner. This is a particularly overcomplicated and laborious technique. Further, the system only allows for one image type to be transmitted at any one time.

The present invention aims to overcome, or at least alleviate, some or all of the afore-mentioned problems, or to at least provide the public with a useful choice.

### SUMMARY OF THE INVENTION

According to one aspect, the present invention provides a method of transmitting multiple data segments of a disk image from a server to at least two clients that have differing disk image types, the method including the steps of the server: streaming multiple data segments forming at least part of two different disk image types to the clients, and interlacing data segments of a first image type with data segments of a second image type.

According to a further aspect, the present invention provides a method of transmitting a disk image from a client to a server, the method including the steps of: the client determining whether a disk image suitable for the client is currently stored on a database accessible by the server, and, upon a negative determination, the server uploading a disk image from the client to the server for storage in the database.

According to yet a further aspect, the present invention provides a system including a server arranged to transmit multiple data segments of a disk image to at least two clients that have differing disk image types, the server arranged to stream multiple data segments forming at least part of two different disk image types to the clients, and interlace data segments of a first image type with data segments of a second image type.

According to yet a further aspect, the present invention provides a system including a client arranged to transmitting a disk image to a server, the client arranged to determine whether a disk image suitable for the client is currently stored on a database accessible by the server, and, upon a negative determination, upload a disk image from the client to the server for storage in the database.

### BRIEF DESCRIPTION OF THE DRAWINGS

Embodiments of the present invention will now be described, by way of example only, with reference to the accompanying drawings, in which:

FIG. 1 shows a system block diagram according to an embodiment of the present invention;

FIG. 2 shows a graphical representation of interlacing multiple data segments for multiple image types being multicast to multiple image clients according to an embodiment of the present invention;

### DETAILED DESCRIPTION OF THE INVENTION

### First Embodiment

Embodiments of the present invention as described in more detail below provide an efficient and fast way to create and transmit disk images from a server to computers, or image clients, that are connected to a network.

Throughout this description, the term ‘disk’ is a reference to a storage medium for storing data and includes hard drives, as well as solid state hard drives.

When the server recognizes the type of computer that has been connected to the server's network, the server can either immediately start to transmit the image to that computer or, depending on the computer's configuration, request that the computer confirms the type of image that is to be transmitted by the server to the computer.

Further, if an image of a certain type is already being transmitted to a computer on the network then further computers which require the same image type can be added to the network dynamically so that the new computers can immediately start to receive the image data being transmitted without the need to halt the transmission or require any further configuration of the transmission.

The images are transmitted by the server to multiple computers by multicasting the images. Different computers may require different image types. Therefore different image types are multicast in segments, where the segments of one image type are interlaced with segments of another image type. In this manner, multiple computers requiring different image types are able to simultaneously receive their associated disk images.

Computers that require different image types can all receive their associated disk images at the same time across the same network. For example, the different image types may be required due to the type of computer, such as laptops, desktops, notebooks etc; different manufacturer's of the computer, such as Philips, Toshiba, Sony etc; and different operating systems that run on the computer, such as Apple Macs and Personal Computers.

If a computer is connected to the network and there is no suitable image type stored in the database for that computer then the server can interrogate the computer to see if the computer already has an image stored on the computer's disk. If the computer does have an image stored, the server will request if that image can be copied and stored in the image database. If the request is allowed by the computer, the image is uploaded to the image database to allow further computers of this type to subsequently access that type of disk image.

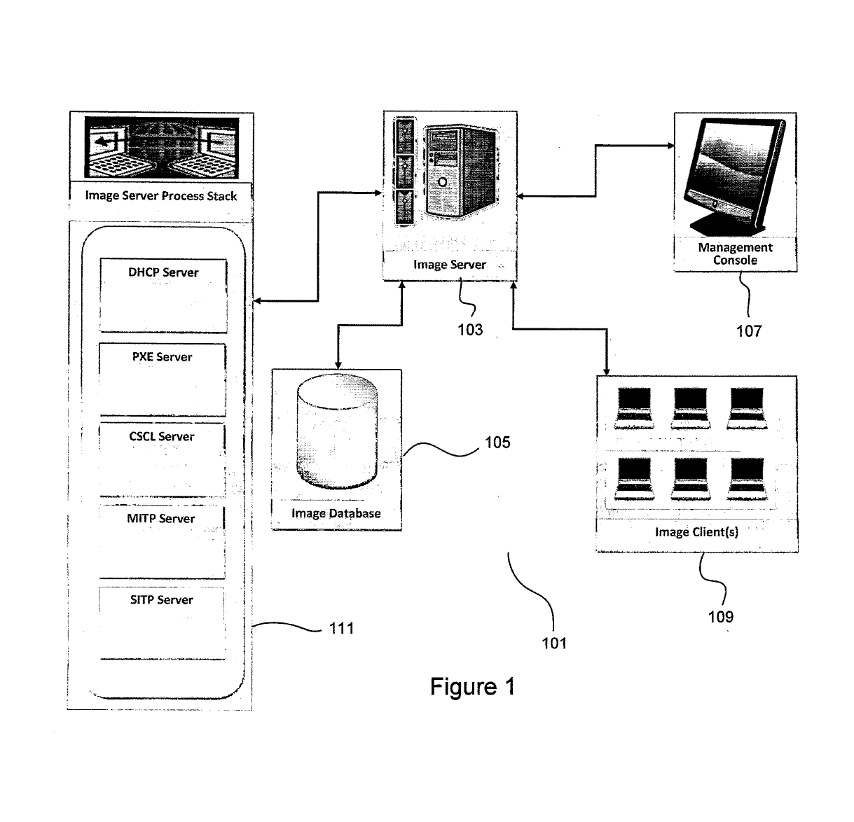

FIG. 1 shows a block diagram of a system used to implement an embodiment of the present invention.

The system forms a network 101, which includes an image server 103. The image server may be any computing system that is able to run the herein described imaging software and that can be attached to a network. Hosted by the image server is an image server database 105. The database may be any suitable database from a built in database within the image server to a stand alone database, such as an Oracle database, for example. The server and database may be chosen according to the operators needs and can be scaled according to their requirements.

Also connected to the image server is a management console 107, which enables user to manage and control the imaging process. Various image clients 109 are arranged to be connected to the network.

The image server database 105 stores disk images that are used for transmission to the image clients 109. The database also stores a variety of information about each of the disk images such as, for example, the model of machine or operating system that it is able to be used on. Other information used to identify the disk image may also be stored. This information may be included within the data segments header as explained below. The information may include, for example, the manufacturer of the image client, a personalised name for the image, an image version, a company name or any other form of ID that may be entered using free text. This information determines the type of disk image that the image client would require in order for the image client to work correctly if the disk image is later loaded onto the image client.

The image server 103 also hosts an image server process stack 111, which includes a set of software components that are used to provide and receive images from the image clients 109.

The image server process stack 111 includes a DHCP (Dynamic Host Configuration Protocol) server, a PXE (Pre-execution environment) server, a CSCL (CURE Simple Communication Layer) server, a MITP (Multi-Image Transfer Protocol) server and a SITP (Single-Image Transfer Protocol) server.

The DHCP server automates the assignment of reusable IP addresses within the domain of the server. The assignment if the IP addresses enables the image clients to seamlessly connect and disconnect from the network. DHCP is a standard protocol defined in RFC 1531 (Request for comment) from the Network Working Group in 1993.

The PXE server provides an environment in which computing systems, such as the image clients, can start up, or boot up, using a network interface independently of the available data storage devices, such as the client's hard disk drive, or any installed operating systems. The PXE was introduced as part of the Wired For Management framework from Intel in 1999. The PXE server is controlled by a PXE UNDI (Universal Network Driver Interface)/TFTP layer.

The CSCL is a communication layer devised by the applicant for use with the server to enable unicast communication between the server and a client.

MITP is an image transfer protocol devised by the applicant for use when the server is transferring multiple disk images to the image clients. The MITP protocol includes three layers, which are the PXE UNDI/TFTP transfer layer, the CSCL and a Multi Data Segment Transfer Layer (MDSTL).

SITP is an image transfer protocol devised by the applicant to be used when the server arranges a single image to be transferred to the image database from an image client.

The various protocols and layers are described in more detail below.

Image clients are computing machines that are attached to the server network with the intention of configuring them by downloading an image from the image database. The image itself may be any type of image, and includes an image that contains no data. This may be particularly useful where a user wishes to transfer a blank image to a number of image clients in order to wipe the image client's disks.

It is also possible for an image client to upload an image to the image database if an image does not exist in the database for the given type of image client. That is, the image client's disk image stored on its local hard drive may be uploaded for storage in the image database.

The following describes the format of the disk image files that are stored within the image database. The raw disk image file includes the following information.

A detailed description of the layout of the original drive layout, which includes the drive geometry, such as the cylinders, tracks, sectors and bytes, and the partition setup, such as the master boot record (MBR) or the GPT (GUID (Globally Unique Identifier) Partition Table).

An independent data segments header, where each segment header includes the starting position for the segment, a bit array of each sector in the segment, the compressed data of the segment and a CRC (Cyclic Redundancy Check) value for the data. Further information may also be stored in the header in the form of the original disk information, geometry details of the disk (including details of cylinders and tracks etc.), unique GUID of server in order to identify which server has provided the image, as well as information used to identify the disk image type as herein described.

Independent data segments for the entire drive.

Device hardware information that includes information from the original image client. This information includes the name of the manufacturer of the device hardware of the image client, the product name or names of the device hardware of the image client, the version number of the device hardware and the UID of the device hardware.

User defined information, such as any modifiable details of the image file.

The following describes how an image client connects to the network as shown in FIG. 1 in order to access the images stored in the image database.

An image client that requires an image is added to the server network by allowing the image client to automatically boot to the network via its network card. The image client is able to automatically boot to the network through the use of the PXE server and PXE UNDI/TFTP transfer layer. This layer is a unicast layer that is used to enable the image clients to start up and enter a state whereby the image client is able to receive and store an associated image.

That is, the network card on the image client identifies itself to the server via its MAC (Media Access Control) address. The server subsequently allocates an IP address to the image client to enable the server and image client to communicate effectively. The server transmits information to the image client that identifies where boot information is stored to enable the image client to boot into a pre-execution environment. When the image client is started in the PXE mode it can connect to the server to receive the required kernel from the server for booting. The required kernel is sent from the server using TFTP [Trivial File Transfer Protocol] as described by the RFC 783 of the Internet RFC Archives. The server conforms to all the Intel PXE standards to enable computer devices to boot up into an executing environment.

In this embodiment, the image client makes a TFTP request to the server to download a CURE.PXE pre-execution environment for a CURE Linux operating system.

The CURE.PXE provides information to the image client to enable the image client to download the required kernel CURE.KN, which is the CURE Linux kernel. Also, the image client is provided with the contents of CURE.RT, which is a directory that contains an application (CURE.elf) that retrieves and applies the disk image to the image client.

Thus, the image client downloads CURE.KN and the contents of the CURE.RT directory from the server, and installs the CURE.KN operating system in order to boot to the CURE operating system. The CURE operating system then automatically mounts the .RT (root) directory and runs configuration scripts to load devices and network connections before running the CURE.elf application itself.

The CURE application is executed on the image clients to enable the image clients to communicate effectively with the server and the image database to enable images to be transferred to the image clients, or to allow images on the image client to be uploaded to the image database.

The CURE application is used to determine whether the server already has an image of the type required by the image client. If the required image is stored within the image database, the image is transferred to the image client via the MITP layer, as explained in more detail below.

Optionally, the image client may display a menu as part of a “pre” application stored on the image client that allows an operator to select an image of a particular type from the image database in order to transfer and install that image.

Alternatively, the image client may display a list of stored images that are available for the particular type of image client when there is more than one possible image available, or provide a list of available types of image in cases where the image client may use more than one type of image. That is, the server determines which stored images may be used on the image client and provides a list of available images and/or type of images for the user to choose from. Upon selection by the user on the image client, the server transfers the selected image.

If the required image or image type is not available from the image database, a menu may be displayed that enables a user to upload any existing image that is currently located on the image client disk to the image database via the SITP layer.

Further, the system may also analyse the image already stored on the image client to determine whether there is a suitable alternative image available on the image database that will provide substantially the same functionality. By reducing the number of different types of images that can be used, the amount of memory required to store the images is substantially reduced. Further, the transmission time for the disk images is substantially reduced due to the reduced number of different disk image types that would be required to be transmitted at any one time.

As an alternative, the image database may store complete file structures rather than data segments, where those file structures are common across a number of image clients.

The following describes how images, including images of different types, are transferred from the image database to image clients.

The Multiple Image Transfer Protocol [MITP] is used to transfer image data from the image database to the client via the server. The transfer is enabled by utilising a three layered unicast/multicast, set speed, transfer across the network between the server and the image clients. The three layers of the MITP Protocol are the PXE UNDI/TFTP transfer layer, the Client Synchronized Communication Layer and the Multi Data Segment Transfer Layer.

The steps involved in providing the pre-execution environment utilising the PXE UNDI/TFTP transfer layer have been discussed above.

The Client Synchronized Communication Layer is a unicast layer that is used to enable the client and the server to directly communicate with each other. In order for the image client to connect to the server it sends its hardware information to the server via the CSCL. This communication layer will thus enable the server to determine the type of image that the image client requires, which will then enable the server to determine whether such an image type is available for the image client and so enable the server to inform the image client that the image type required is available or not.

As previously mentioned, if multiple images of a particular type, multiple suitable types, are available for the image client, the server sends a list to the image client to enable a user to select which image they want to transfer.

The CSCL also enables pre set tasks to be performed as assigned by the server or to enable the image client to display any available tasks. For example, the pre set tasks may include data destruction using any suitable format, such as the US DoD standard to a specified level. Also, the pre set task may include a form of hardware testing.

Also, the CSCL enables the image client to send status information based on each independent data segment that the image client has or has not yet received from the server for the image type that has been requested. This is enabled by the image client, which creates a map of the bits forming the image. The map identifies a number of segments or chunks that make up the disk image. This map is sent to the server so that the server and the image client can keep track of which segments have been received. In situations where an image client has received a particular segment, the server will make an indication in its records that the image client has received that segment. If, when the image client processes the data segment it has received, the client determines that the data is corrupt or incomplete it will inform the server that the previously received data segment is required to be re-transmitted. The server will then update the status information in the bit map information for that data segment for that image server to enable the data segment to be resent.

Although there will be situations where the images of several image clients are identical, for example, because they have previously received the same disk image, it will be understood that there will be scenarios where image clients have common data segments with other image clients, and other data segments that are unique to that image client.

Further, the CSCL enables the image client to send success or failure messages with regards to the receipt and processing of data segments between the image client and server.

The Multi Data Segment Transfer Layer is a multicast layer that is used to transfer data segments that form an image from the image database via the server to any image clients that have requested that image. Each data segment includes a task identification that identifies the type of image that the data within the segment is associated with. Each data segment also includes a segment identification that provides a unique identification for each segment associated with a specific image. Finally, each data segment also includes the actual data to enable the image to be loaded onto the image client.

The data segments are transmitted by the server in an order which is determined on a need basis. The server arranges the order of transfer of segments from the most requested to least requested segments. The order of the required segments is determined from the information that was sent as part of the CSCL communications described above which enables the image client to indicate to the server which segments the client had received. Also, only data segments for image types that have been requested by image clients are transmitted.

At any one time, to reduce the amount of information being transmitted, only one segment from any one type of disk image is transmitted. The segment transmitted is based on the most required segment. In addition, to avoid the situation where a number of image clients are waiting for one or more single unique image segments, the system also prioritises at least one of the image clients so that the prioritised disk image client receives all its required data segments first.

Optionally, the system may utilise the fact that an image client has received a complete disk image where the server is being overloaded. That is, when the server reaches a threshold point or becomes inactive, and an image client has received a full image, the image client may then start acting as a server to continue sending the image to other image clients.

All data segments are transferred from the image database via the server until all image clients have successfully responded that all their requested segments have been received. The server is arranged to transfer all the data segments for multiple image types to the image clients that request those images. Multiple data segments are interlaced during the transmission, where those data segments consist of data segments from different image types depending on which image types have been requested by the image clients connected to the server.

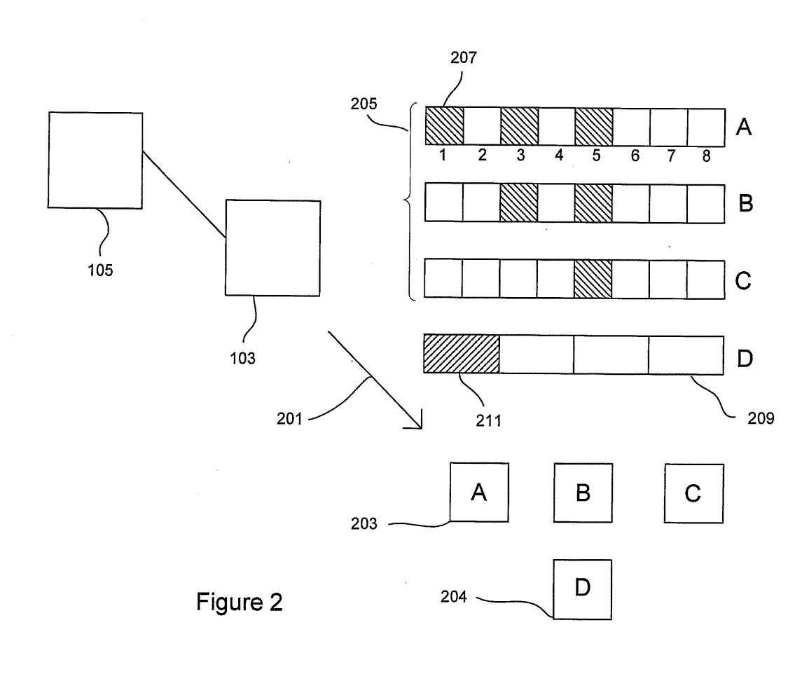

FIG. 2 shows a graphical representation of interlaced multiple data segments for multiple image types being multicast to multiple image clients.

The image database 105 is connected to the server 103 as described above. The image server multicasts 201 data segments for a number of image types. In the described scenario, there are three image clients 203 A, B, and C that all require the same image type. Image client D requires a different image type 209.

Maps 205 of the bits associated with the specific image type required by these image clients are stored in the server and at the image clients themselves. The data segments are identified (1, 2, 3 etc). When image client A joins the network, the server will send out segment 1 (207), and then the next segments in order. It will be understood that the data segments are not required to be sent out in any particular order, but for clarity of this explanation it is assumed they are.

If client B then joins the network while A is currently receiving the second segment, B will start receiving data segments from the transmission of the third data segment. Likewise, if C joins the network while the fourth segment is in transmission, it will start receiving the segments from the transmission of the fifth segment. The server will be aware of which of the segments in the image type 205 is most required and will send those first, while also taking into account that image client A has priority over other image clients.

When image client D joins the network, the map 209 of the bits of the image type required by D is transferred to the server from the client. The server will then interlace the segments for the image type requested by D with the segments for the image type requested by A, B and C.

As each of the image clients receive the data segments, the data may be cached in order to provide sufficient time for the image client to process the data.

The image files stored in the image database are initially generated from images obtained by image clients that are attached to the server network. That is, if an image client connects to the server network and it is determined that an image is not stored in the image database, or an operator instructs the server to extract the image from the image client using the management console, the image is then extracted and uploaded to the image database.

The following steps are carried out to enable an image from an image client to be uploaded to the image database via the server.

The image client with the image that is required to be uploaded to the image database is attached to the server network. The image client identifies itself to the server via its MAC (Media Access Control) address in the same way as described above. The server subsequently allocates an IP address to the image client to enable the server and image client to communicate effectively. The server transmits information to the image client that identifies where boot information is stored to enable the image client to boot into a pre-execution environment, as discussed above. Once the CURE files are downloaded and the application is run in a similar fashion as described above the application invites the operator to upload the image from the image client. The user may use the management console to request the upload, or use a “pre” application loaded onto the image client to request the upload. In addition, as explained above, the “pre” application or the management console may be used to provide additional services, such as, for example, wiping the disk or checking hardware.

The CURE application copies the disk image, compresses it and streams it back to the server using SITP. When the server has determined that such a transmission is taking place, all other transmissions across the network are suspended until the SITP transmission has completed. Any new image clients connected to the network while the SITP transmission is underway are forced to wait until the transmission has completed before connecting to the server.

That is, the system is set up so that when an image is being uploaded to the server the server waits until it has received the entire image before it starts to transmit images again. Also, when a server receives a request to upload an image, that image is not allowed to be uploaded until the server has finished transmitting all the image segments that have been requested by image clients.

The process for transmitting the disk image back to the server using SITP includes sending an image header, a geometry and partition setup (as explained above), an independent data segments header (raw base header with basic data), device hardware information, each independent data segment (sent sequentially, one after another), independent data segments header (complete with all data) and a container closer to close the image.

Until the container closer is received by the server from the image client the server treats the data as temporary data and the image is unable to be received by future clients.

The network usage of the MITP is controlled by the server to stop bottlenecks in the network, and to keep the network efficiency high.

That is, during standard activity, such as when transferring images from the server to the clients, 80% of the network bandwidth is used for transmitting data using the multi data segment transfer layer, 15% of the network bandwidth is used by the client synchronized communication layer and 5% of the network bandwidth is left for listening to the PXE UNDI/TFTP transfer layer for connections.

When a client tries to connect to the network via the PXE the server throttles the Multi Data Segment Transfer Layer down to 20%/10%/0% as the more clients try to connect.

As the clients successfully connect the server brings the network back up to standard activity as discussed above.

It will be understood that the percentage values given are examples only and that other throttle values may be used or varied based on the condition of the network and the image clients attempting to connect to the network.

Optionally, the management controller may be adapted to provide instructions to the server based on instructions provided by a user. For example, instructions may be provided by a user by entering them via the management controller user interface. Alternatively, the instructions may be provided to the server by using any other suitable communication medium and device.

The instructions provided by the user are used to control the order and number of types of images that are transferred to clients that are connecting to the server. That is, the instructions control the server so that it transfers predefined image types to a specific predefined number or quantity of attached clients. For example, the server may be instructed to only transfer an image of type X to the next 5 clients that connect to the server, followed by an image of type Y to the next 7 clients that connect to the server. In this way, a network of computers (clients) may be set up to connect and retrieve their required image types in a specific order as pre-defined by the user, even when there is more than one image available for the particular type of client.

### Further Embodiments

It will be understood that the embodiments of the present invention described herein are by way of example only, and that various changes and modifications may be made without departing from the scope of invention.

1. A method of transmitting multiple data segments of a disk image from a server to at least two clients that have differing disk image types, the method including the steps of the server:
streaming multiple data segments forming at least part of two different disk image types to the clients, and
interlacing data segments of a first image type with data segments of a second image type.

2. The method of claim 1 further including the step of multicasting the data segments to the clients.

3. The method of claim 1 further including the steps of the server detecting which disk image type the client has requested, detecting the status of the data segments for the requested disk image type, and determining which data segments to send to the client based on the detected disk image type and the status.

4. The method of claim 3 further including the steps of the server determining which data segments are most required by the clients, and sending the most required data segments first.

5. The method of claim 3 further including the step of the server determining which client requested the data segments first, and prioritising the determined client for receipt of the data segments.

6. The method of claim 1 further including the step of requesting continuation of the disk image type of the client before transmitting the data segments.

7. The method of claim 1 further including the step of inserting an identification tag within the data segment that identifies the type of disk image that the data segments form.

8. The method of claim 7 further including the step of the client receiving data segments that have an identification tag associated with the client's disk image type.

9. The method of claim 8 further including the step of the client rejecting data segments that have an identification tag not associated with the client's disk image type.

10. The method of claim 1, wherein the disk image type is defined from at least one of the group consisting of: the model of the client computer; the manufacturer of the client computer; the operating system of the client computer; a personalised name; an image version; a company identifier; a unique freeform text identifier.

11. The method of claim 1 further including the step of the server streaming disk images of a pre-defined type and quantity to the clients.

12. A method of transmitting a disk image from a client to a server, the method including the steps of:
the client determining whether a disk image suitable for the client is currently stored on a database accessible by the server, and, upon a negative determination,
the server uploading a disk image from the client to the server for storage in the database.

13. The method of claim 12 further including the steps of determining whether a disk image suitable for the client is stored on the client, and upon a negative determination, creating a disk image suitable for the client.

14. The method of claim 13 further including the step of storing the created disk image on the client.

15. The method of claim 13 further including the step of storing the created disk image in the database.

16. The method of claim 12 further including the step of automatically connecting the client to the server in a network by booting the client to the network via the client's network card.

17. The method of claim 16 further including the step of the server providing a pre execution environment to the client and the client installing the pre execution environment to enable the downloading of a disk imaging application.

18. The method of claim 17, wherein the disk imaging application enables the client to communicate with the server in order to determine whether the disk image suitable for the client is currently stored on the database.

19. The method of claim 16 further including the step of the server throttling back existing connections when a client is connecting to the server.

20. A system including a server arranged to transmit multiple data segments of a disk image to at least two clients that have differing disk image types, the server arranged to stream multiple data segments forming at least part of two different disk image types to the clients, and interlace data segments of a first image type with data segments of a second image type.

21. The system of claim 20 wherein the server is further arranged to multicast the data segments to the clients.

22. The system of claim 20 wherein the server is further arranged to detect which disk image type the client has requested, detect the status of the data segments for the requested disk image type, and determine which data segments to send to the client based on the detected disk image type and the status.

23. The system of claim 22 wherein the server is further arranged to determine which data segments are most required by the clients, and send the most required data segments first.

24. The system of claim 22 wherein the server is further arranged to determine which client requested the data segments first, and prioritising the determined client for receipt of the data segments.

25. The system of claim 20 wherein the server is further arranged to request confirmation of the disk image type of the client before transmitting the data segments.

26. The system of claim 20 wherein the server is further arranged to insert an identification tag within the data segment that identifies the type of disk image that the data segments form.

27. The system of claim 26 wherein the client is arranged to receive data segments that have an identification tag associated with the client's disk image type.

28. The system of claim 27 wherein the client is further arranged to reject data segments that have an identification tag not associated with the client's disk image type.

29. The system of claim 20, wherein the disk image type is defined from at least one of the group consisting of: the model of the client computer; the manufacturer of the client computer; the operating system of the client computer; a personalised name; an image version; a company identifier; a unique freeform text identifier.

30. The system of claim 20, wherein the server is arranged to stream disk images of a pre-defined type and quantity to the clients.

31. A system including a client arranged to transmitting a disk image to a server, the client arranged to determine whether a disk image suitable for the client is currently stored on a database accessible by the server, and, upon a negative determination, upload a disk image from the client to the server for storage in the database.

32. The system of claim 31 wherein the server is arranged to determine whether a disk image suitable for the client is stored on the client, and upon a negative determination, the client is arranged to identify a disk image suitable for the client.

33. The system of claim 32 wherein the client is arranged to store the disk image on the client.

34. The system of claim 32 wherein the server is arranged to store the created disk image in the database.

35. The system of claim 31 wherein the client is arranged to automatically connect to the server in a network by booting to the network via the client's network card.

36. The system of claim 35 wherein the server is arranged to provide a pre execution environment to the client and the client is arranged to install the pre execution environment to enable the downloading of a disk imaging application.

37. The system of claim 36, wherein the disk imaging application enables the client to communicate with the server in order to determine whether the disk image suitable for the client is currently stored on the database.

38. The system of claim 35 wherein the server is arranged to throttle back existing connections when a client is connecting to the server.
